(19) United States
(12) Patent Application Publication
(10) Pub. No.: US 2006/0107303 A1
(43) Pub. Date: May 18, 2006

(54) Content specification for media streams

(75) Inventors: George William Erhart, Pataskala, OH (US); Valentine C. Matula, Granville, OH (US); David Joseph Skiba, Golden, CO (US)

Correspondence Address: DEMONT & BREYER, LLC, SUITE 250, 100 COMMONS WAY, HOLMDEL, NJ, 07733, US

(73) Assignee: Avaya Technology Corp., Basking Ridge, NJ (US)

(21) Appl. No.: 10/989,136

(22) Filed: Nov. 15, 2004

(51) Int. Cl. G06F 13/00; H04N 7/16; H04N 5/445

(52) U.S. Cl. 725/135; 725/37

(57) ABSTRACT

An apparatus and methods are disclosed that enable a user of a telecommunications terminal to dynamically supplant the video content of an outgoing media stream (e.g., an outgoing videoconference stream, etc.) with video from a document (e.g., a PowerPoint® file, a Windows Media Video [WMV] file, etc.) via the terminal's graphical user interface (GUI). When a user drag-and-drops a graphical object that is associated with a document onto a graphical object that is associated with the outgoing media stream, the video content of the outgoing video stream is supplanted with video content from the document. Subsequently, a user can drag-and-drop a document icon away from the second graphical object to restore the video content of the outgoing media stream to its prior source.

### FIELD OF THE INVENTION

The present invention relates to telecommunications in general, and, more particularly, to specifying the content of transmitted media streams.

### BACKGROUND OF THE INVENTION

As bandwidth has become more abundant and available, transmission of multimedia content is gaining in popularity with both home and business users. For example, a user might record a message that comprises video and audio and transmit the message to a remote user (e.g., as an email attachment, as streaming content, etc.). As another example, in a videoconference, video and audio that are captured at a telecommunications terminal (e.g., a desktop computer, a personal digital assistant [PDA], a cellular telephone, etc.) are transmitted to one or more remote telecommunications terminals that participate in the conference.

FIG. 1 depicts telecommunications terminal 100, in this case a desktop personal computer, in accordance with the prior art. Telecommunications terminal 100 comprises processing unit 101, display 102, speaker 103, webcam 104, and microphone 105, interconnected as shown. As shown in FIG. 2, a user of telecommunications terminal 100 might use videoconferencing software to transmit video and audio captured at webcam 104 and microphone 105, respectively, over telecommunications network 110 (e.g., the Internet, etc.) to remote telecommunications terminal 120. Similarly, a user of telecommunications terminal 100 might use a content authoring application to create multimedia content, and communications software (e.g., an email client, a streaming application, etc.) to transmit the content to remote telecommunications terminal 120 via telecommunications network 110. Multimedia content at telecommunications terminal 100 (e.g., remote content received via telecommunications network 110, content stored locally, etc.) is output to a user via display 102 (e.g., in window 106, etc.) and speaker 103, in well-known fashion.

### SUMMARY OF THE INVENTION

In many situations, it would be advantageous if a telecommunications terminal user who is engaged in a videoconference could dynamically supplant the video content of the outgoing media stream (e.g., video of the user talking, video of a whiteboard that the user is writing on, etc.) with alternative video content (e.g., a PowerPoint® presentation, a recorded video segment, etc.), while maintaining the audio content of the outgoing media stream (e.g., the user's speech, etc.). It would also be advantageous for the user to be able to easily switch back to the transmission of the original video content at any time, and for the original video content to automatically resume when the alternative video content has concluded.

The present invention enables a user of a telecommunications terminal to dynamically supplant the video content of an outgoing media stream (e.g., an outgoing videoconference stream, etc.) with video associated with a document (e.g., a PowerPoint® file, a Windows Media Video [WMV] file, etc.) via the terminal's graphical user interface (GUI). In particular, in the first illustrative embodiment of the present invention, when a user drag-and-drops a first graphical object that is associated with a document (e.g., an icon, etc.) onto a second graphical object that is associated with the outgoing media stream (e.g., an icon, a videoconference application window, etc.), the video content of the outgoing video stream is supplanted with video content associated with the document. Subsequently, a user can drag-and-drop a document icon away from the second graphical object to restore the video content of the outgoing media stream to its prior source (e.g., webcam live-video capture, another document, etc.). In addition, if the video content associated with the document concludes, the video content of the outgoing media stream automatically resumes to its prior source.

The second illustrative embodiment of the present invention augments the first illustrative embodiment by adding the audio content associated with the drag-and-dropped document to the audio content of the outgoing media stream. For example, if a user drag-and-drops an icon for a Windows Media Video (WMV) file onto a videoconference application window, audio content from the WMV file (e.g., background music, etc.) is transmitted in addition to the live-audio capture, and the live-video capture is supplanted with the video content of the WMV file. When the user subsequently drag-and-drops the WMV file icon away from the window, the transmitted audio content reverts to the live-audio capture only, and the transmitted video content reverts to the live-video capture.

In the third illustrative embodiment of the present invention, the roles of the audio content and video content are reversed. In other words, the video content of a drag-and-dropped document is added to the live-video capture (e.g., shown side-by-side in a split-screen window, superimposed, etc.) and the live-audio capture is supplanted with the audio content of the document.

The illustrative embodiment comprises: (a) transmitting to a remote telecommunications terminal a first media stream that comprises a first video signal and an audio signal; (b) receiving from the remote telecommunications terminal a second media stream; and (c) when a first graphical object that is associated with a document is drag-and-dropped in a graphical user interface onto a second graphical object that is associated with the first media stream, supplanting the first video signal in the first media stream with a second video signal that is based on the document.

### BRIEF DESCRIPTION OF THE DRAWINGS

FIG. 1 depicts a telecommunications terminal in accordance with the prior art.

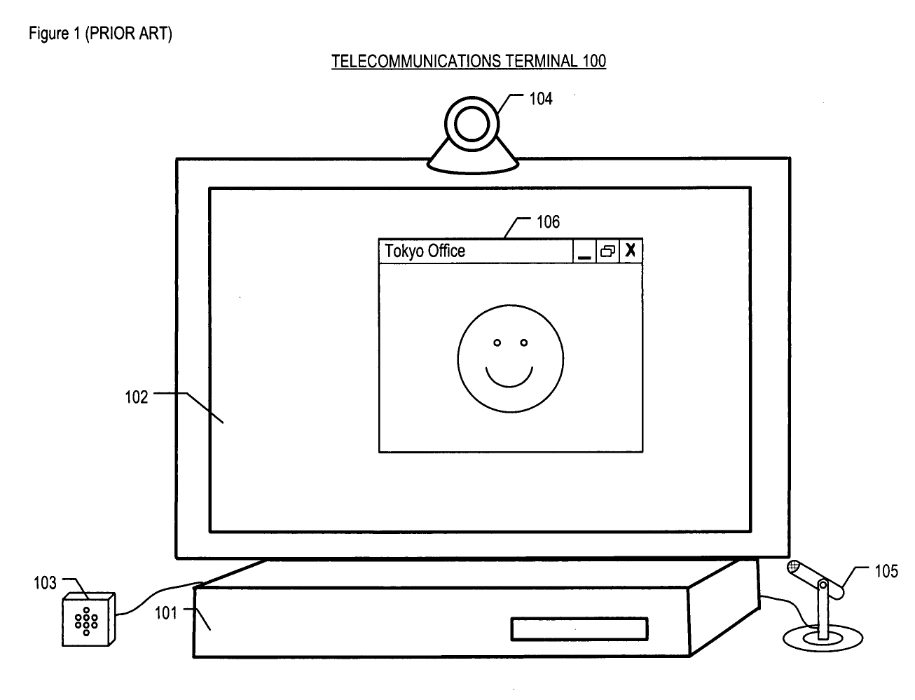

FIG. 2 depicts telecommunications terminal 100, as shown in FIG. 1, communicating with another telecommunications terminal, in accordance with the prior art.

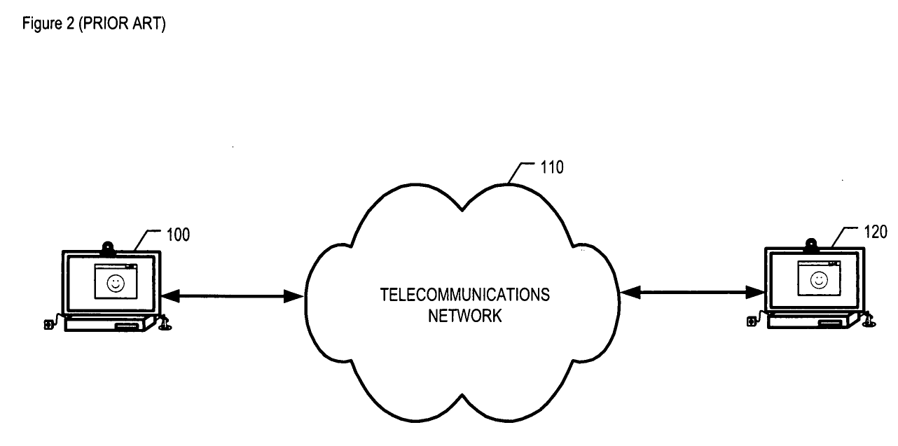

FIG. 3 depicts a telecommunications terminal in accordance with the illustrative embodiments of the present invention.

FIG. 4 depicts a drag-and-drop operation performed by a user of telecommunications terminal 300, as shown in FIG. 3, in accordance with the illustrative embodiments of the present invention.

FIG. 5 depicts telecommunications terminal 300, as shown in FIG. 3, after the drag-and-drop operation of FIG. 4, in accordance with the illustrative embodiments of the present invention.

FIG. 6 depicts an alternative drag-and-drop operation to the drag-and-drop operation of FIG. 4, in accordance with the illustrative embodiments of the present invention.

FIG. 7 depicts a drag-and-drop operation performed by a user of telecommunications terminal 300 after the drag-and-drop operation of FIG. 4, in accordance with the illustrative embodiments of the present invention.

FIG. 8 depicts an alternative drag-and-drop operation to the drag-and-drop operation of FIG. 7, in accordance with the illustrative embodiments of the present invention.

FIG. 9 depicts a block diagram of the salient components of processing unit 301, as shown in FIG. 3, in accordance with the illustrative embodiments of the present invention.

FIG. 10 depicts a flowchart of the salient tasks of telecommunications terminal 300 in response to the drag-and-drop operations of FIGS. 4 and 7, in accordance with the first illustrative embodiment of the present invention.

FIG. 11 depicts a flowchart of the salient tasks of telecommunications terminal 300 in response to the drag-and-drop operations of FIGS. 4 and 7, in accordance with the second illustrative embodiment of the present invention.

FIG. 12 depicts a flowchart of the salient tasks of telecommunications terminal 300 in response to the drag-and-drop operations of FIGS. 4 and 7, in accordance with the third illustrative embodiment of the present invention.

FIG. 13 depicts a client/server architecture in accordance with the illustrative embodiments of the present invention.

### DETAILED DESCRIPTION

The detailed description is organized into two sections: the first section describes how a user can specify, via the graphical user interface, what content is transmitted by telecommunications terminal 300; and the second section describes the salient hardware and software of telecommunications terminal 300.

User Operation of the Graphical User Interface (GUI)

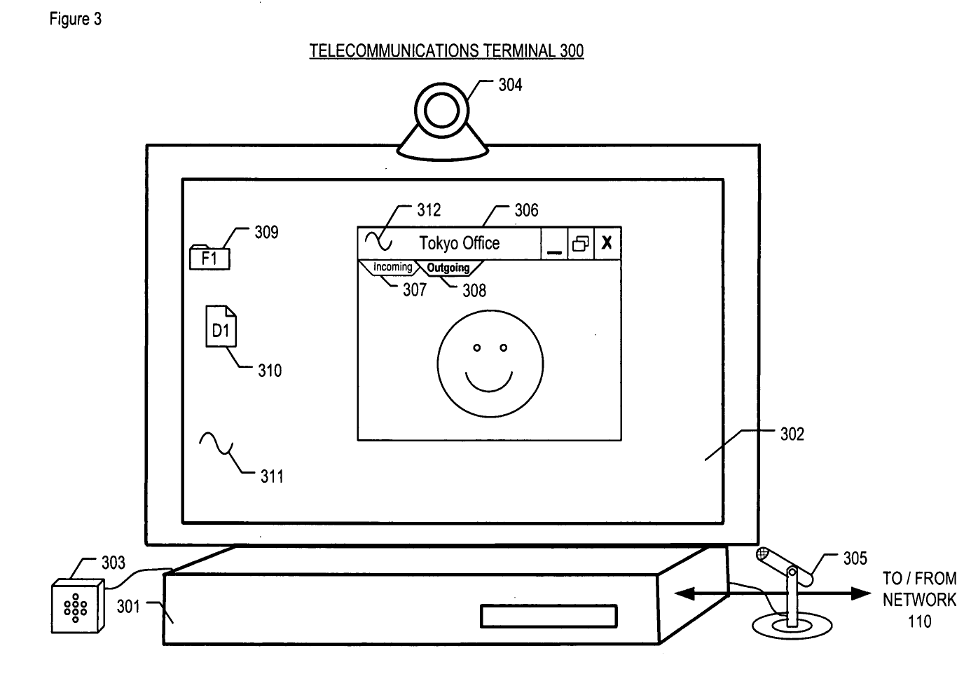

FIG. 3 depicts telecommunications terminal 300 in accordance with the illustrative embodiments of the present invention. Telecommunications terminal 300 comprises processing unit 301, display 302, speaker 303, webcam 304, and microphone 305, interconnected as shown.

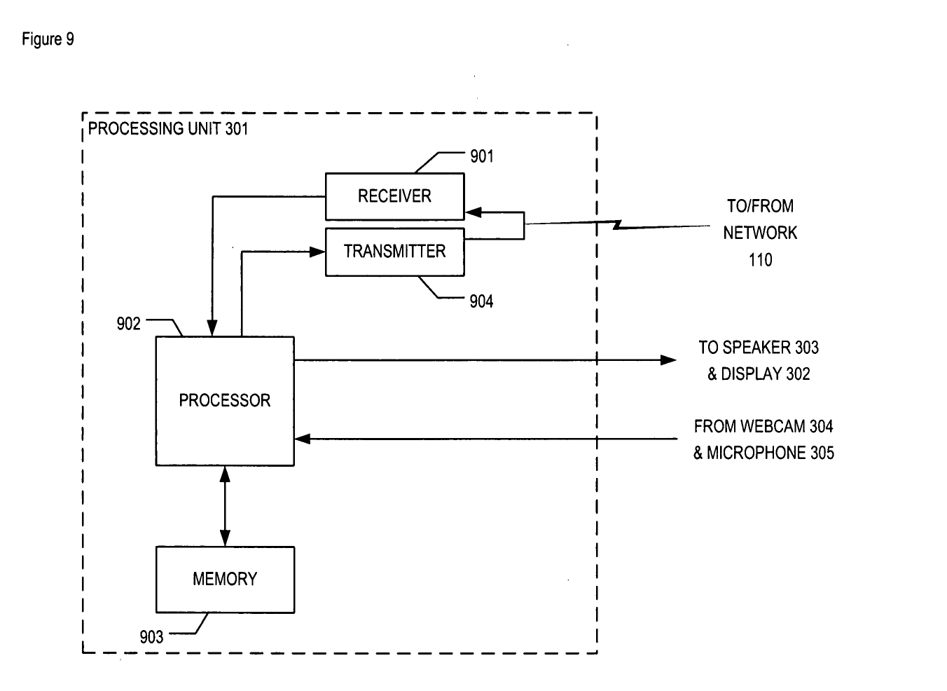

Processing unit 301, like processing unit 101 of the prior art, is capable of executing programs, of storing and retrieving data, and of receiving messages from and transmitting messages to telecommunications network 110, in well-known fashion. In addition, processing unit 301 is capable of outputting signals to display 302 and speaker 303, and of receiving signals from webcam 304, microphone 305, and other input devices (not shown) such as a keyboard, a mouse, a joystick, etc. The internal architecture of processing unit 301 is described in detail below and with respect to FIG. 9.

Display 302, like display 102 of the prior art, is capable of receiving electric signals and of generating visual output (e.g., text, images, etc.) based on these signals, in well-known fashion.

Speaker 303, like speaker 103, is a transducer that is capable of receiving electric signals and of generating acoustic output signals based on the electric signals, in well-known fashion.

Webcam 304, like webcam 104, is capable of receiving photonic signals and of generating electronic image signals, in well-known fashion.

Microphone 305, like microphone 105, is capable of receiving acoustic signals and of generating electric signals based on the acoustic signals, in well-known fashion.

As shown in FIG. 3, display 302 displays window 306, and icons 307 through 310, in well-known fashion.

Window 306 is a rectangular graphical object that is capable of containing text, images, and other graphical objects (e.g., an icon, a drop-down box, a tabbed panel, a subwindow, etc.), in well-known fashion.

Tabbed panels 307 and 308 are graphical objects that, when selected (indicated by boldface), make visible in window 306 an associated set of graphical objects. As shown in FIG. 3, tabbed panel 307 corresponds to an incoming media stream (e.g., a received videoconference stream, etc.) and tabbed panel 308 corresponds to an outgoing media stream (e.g., a transmitted videoconference stream, etc.).

Icon 309 is an image that represents a folder (i.e., a directory) entitled Fl in the file system of processing unit 301, as is commonplace in the art.

Icon 310 is an image that represents a data file D1 in the file system of processing unit 301, as is commonplace in the art. File D1 might contain a word-processing document, a spreadsheet, a PowerPoint® document, etc.

Icon 311 is an image that represents a videoconferencing application, and thus is also associated with the outgoing and incoming media streams of the videoconferencing application.

Icon 312 is an image located in the upper-left corner of window 306 that indicates the source of the video content of the outgoing media stream. In FIG. 3, icon 312 has the same image as the videoconferencing application icon, which indicates that the video capture of webcam 304 is currently being transmitted in the outgoing media stream.

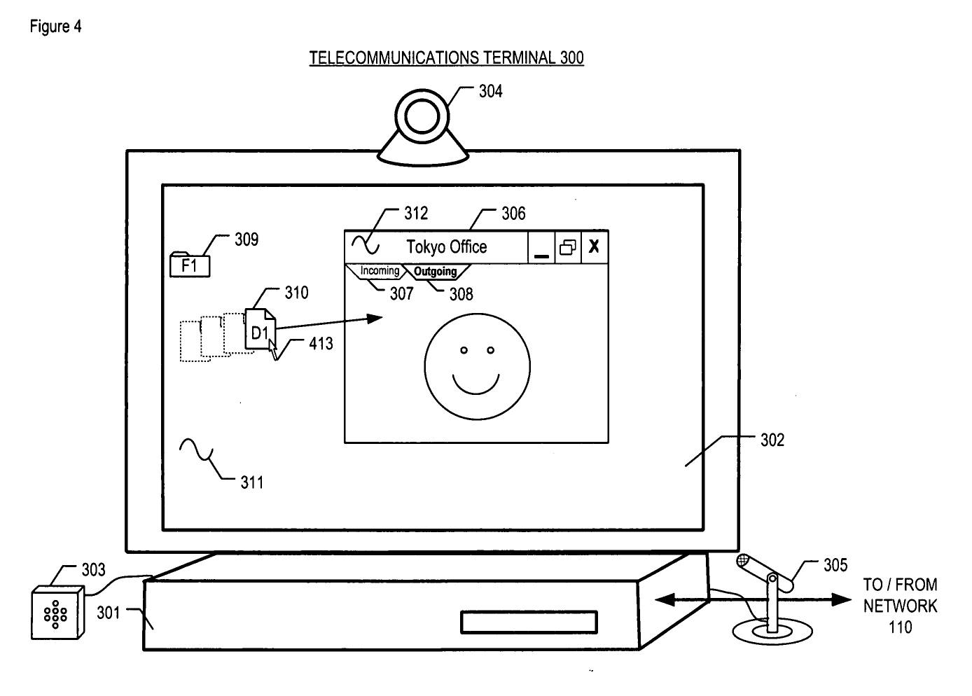

FIG. 4 depicts a drag-and-drop operation performed by a user of telecommunications terminal 300, in accordance with the illustrative embodiments of the present invention. As shown in FIG. 4, the user is drag-and-dropping icon 310, via cursor 413, onto videoconferencing application window 306. As described above, icon 310 represents a document D1. The effect of the drag-and-drop operation, in the first illustrative embodiment of the present invention, is that the video content of document D1 supplants the live-video capture in the outgoing media stream. (The second and third illustrative embodiments of the present invention are described below at the end of this section.)

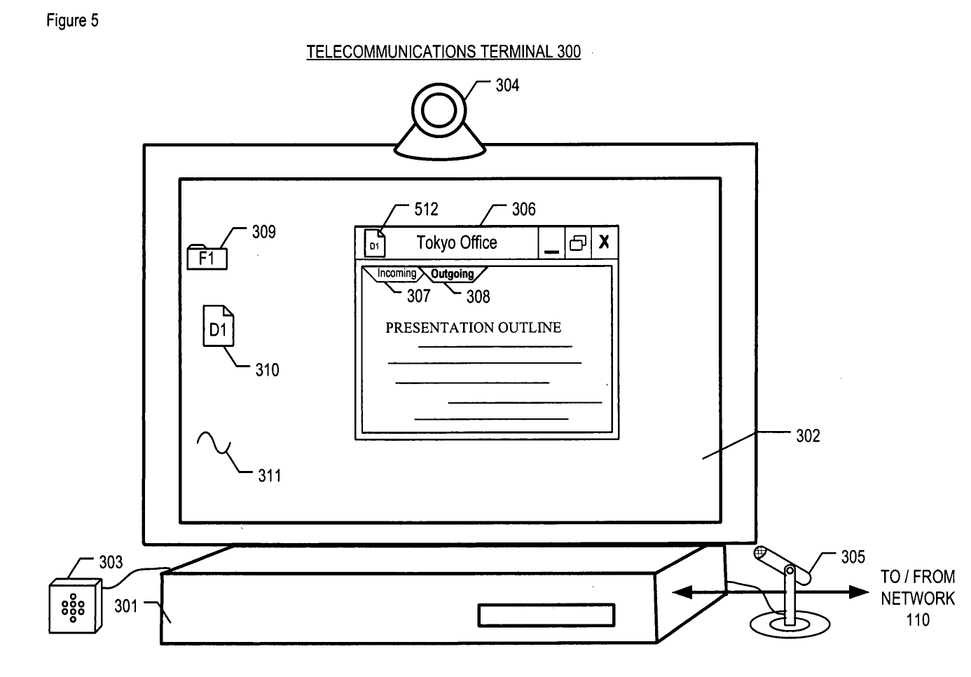

FIG. 5 depicts telecommunications terminal 300, as shown in FIG. 3, after the drag-and-drop operation of FIG. 4, in accordance with the illustrative embodiments of the present invention. As shown in FIG. 5, outgoing tabbed panel 308, which is selected, now shows the video content of D1 (in this case, an illustrative PowerPoint® presentation), and icon 312 is replaced with icon 512, indicating that document D1 is currently the video source for the outgoing media stream. Note that icon 310 is back in its original position; the reason for this is that the drag-and-drop operation did not move the file for D1 in the file system of telecommunications terminal 300.

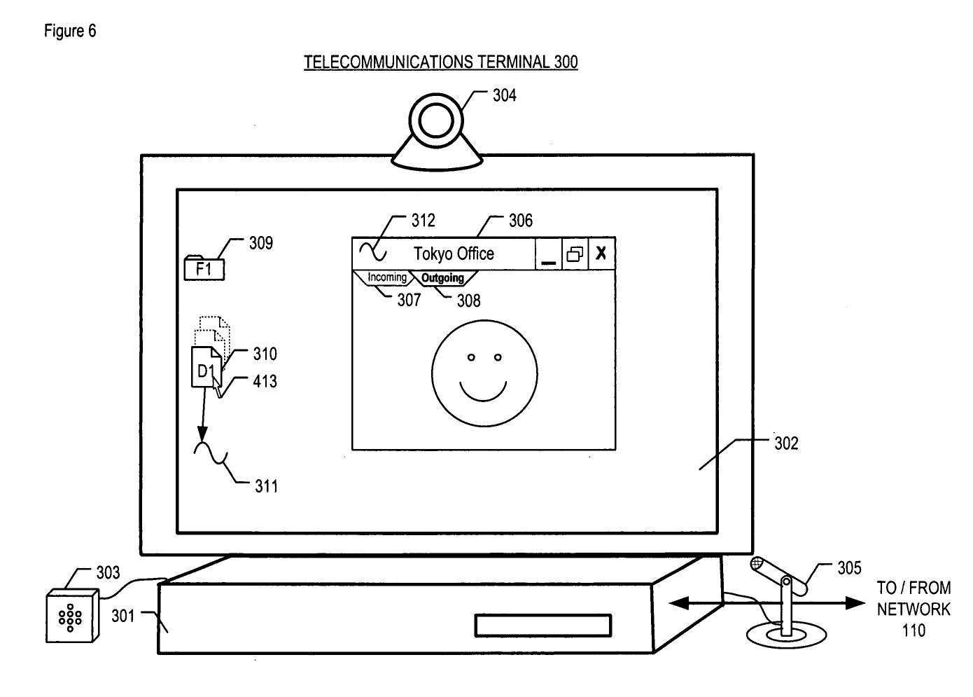

FIG. 6 depicts an alternative drag-and-drop operation to the drag-and-drop operation of FIG. 4, in accordance with the illustrative embodiments of the present invention. As shown in FIG. 6, the user can drag-and-drop icon 310 onto icon 311 (the icon for the videoconferencing application) instead of onto window 306 in order to transmit the video content of D1. After performing the drag-and-drop operation of FIG. 6, display 302 will appear as in FIG. 5, just as for the drag-and-drop operation of FIG. 4.

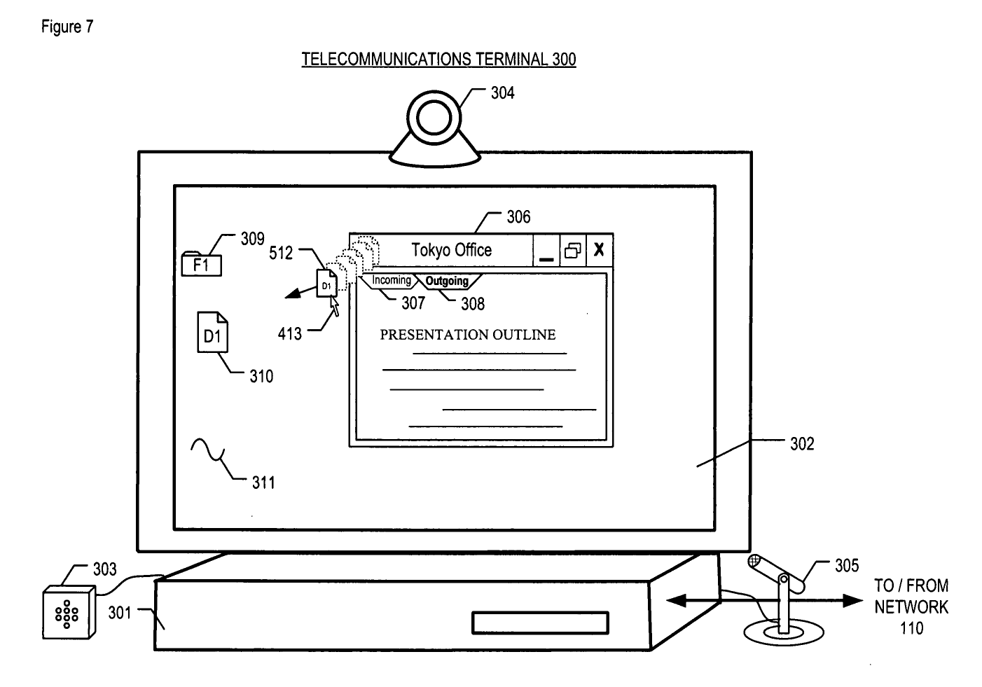

FIG. 7 depicts a drag-and-drop operation performed by a user of telecommunications terminal 300 after the drag-and-drop operation of FIG. 4, in accordance with the illustrative embodiments of the present invention. As shown in FIG. 7, the user is drag-and-dropping icon 512, via cursor 413, away from videoconferencing application window 306. The effect of this drag-and-drop operation, in the first illustrative embodiment of the present invention, is that the video of the outgoing video stream reverts to live-video capture. Thus, after this drag-and-drop operation is performed display 302 will appear once again as in FIG. 3.

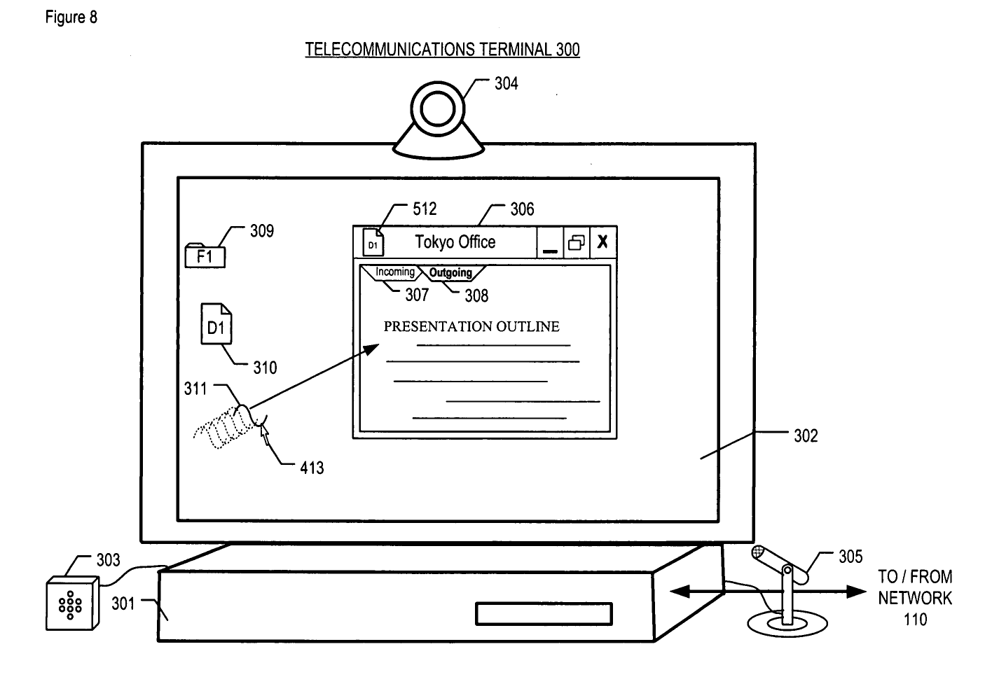

FIG. 8 depicts an alternative drag-and-drop operation to the drag-and-drop operation of FIG. 7, in accordance with the illustrative embodiments of the present invention. As shown in FIG. 6, the user can drag-and-drop icon 311 (the icon for the videoconferencing application) onto videoconferencing application window 306 to revert to live-video capture, instead of drag-and-dropping icon 512 away from window 306. After performing the drag-and-drop operation of FIG. 8, display 302 will appear as in FIG. 3, just as for the drag-and-drop operation of FIG. 7.

The second illustrative embodiment of the present invention augments the behavior of the first illustrative embodiment such that when a user drag-and-drops an icon associated with a document into application window 306, as in FIG. 3, audio content from the document is also added to the outgoing media stream. Similarly, when a user drag-and-drops the upper-left icon (e.g., icon 512, etc.) away from window 306, the audio content of the document represented by the upper-left icon is also removed from the outgoing media stream.

In the third illustrative embodiment of the present invention, the roles of the audio content and video content are reversed. In other words, the video content of a drag-and-dropped document is added to the current video content of the outgoing media stream (e.g., shown side-by-side in a split-screen window, superimposed, etc.) and the audio content of the outgoing media stream is supplanted with the audio content of the document.

Hardware and Software

FIG. 9 depicts a block diagram of the salient components of processing unit 301, in accordance with the illustrative embodiments of the present invention. Processing unit 301 comprises receiver 901, processor 902, memory 903, and transmitter 904, interconnected as shown.

Receiver 901 receives signals from remote telecommunications terminals via telecommunications network 110, and forwards the information encoded in the signals to processor 902, in well-known fashion. It will be clear to those skilled in the art how to make and use receiver 901.

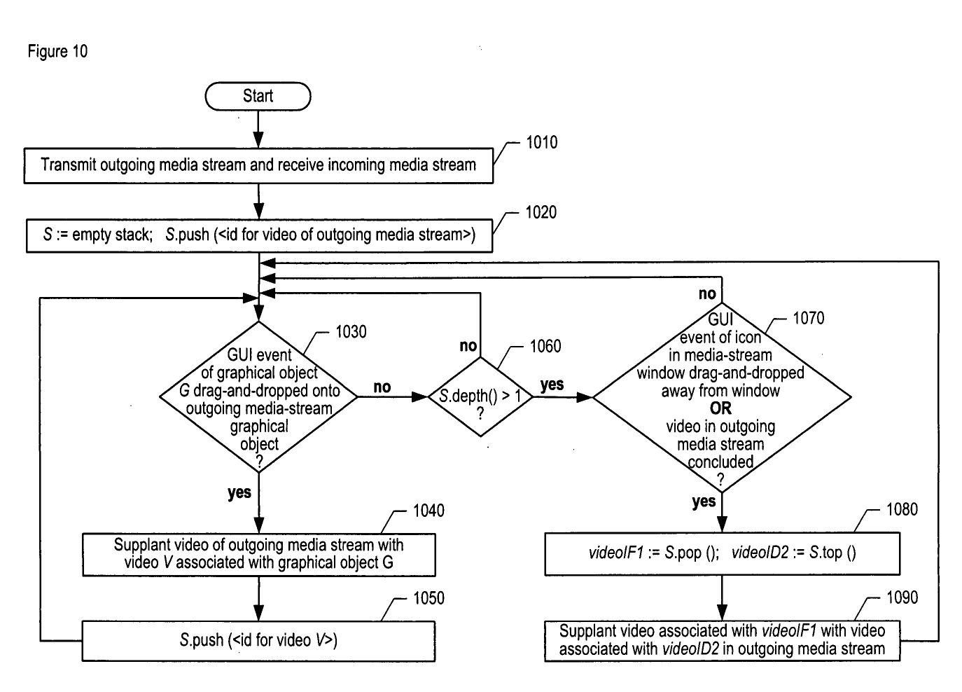

Processor 902 is a general-purpose processor that is capable of: receiving information from receiver 901, webcam 304, microphone 305, and other input devices; reading data from and writing data into memory 903; executing the tasks described below and with respect to FIGS. 10 through 12; outputting signals to display 302 and speaker 303; and transmitting information to transmitter 904. In some alternative embodiments of the present invention, processor 902 might be a special-purpose processor. In either case, it will be clear to those skilled in the art, after reading this specification, how to make and use processor 902.

Memory 903 stores data and executable instructions, as is well-known in the art, and might be any combination of random-access memory (RAM), flash memory, disk drive memory, etc. It will be clear to those skilled in the art, after reading this specification, how to make and use memory 903.

Transmitter 904 receives information from processor 902, and transmits signals that encode this information to remote telecommunications terminals via telecommunications network 110, in well-known fashion. It will be clear to those skilled in the art, after reading this specification, how to make and use transmitter 904.

FIG. 10 depicts a flowchart of the salient tasks of telecommunications terminal 300 in response to the drag-and-drop operations of FIGS. 4 and 7, in accordance with the first illustrative embodiment of the present invention.

At task 1010, telecommunications terminal 300 transmits an outgoing media stream and receives an incoming media stream via telecommunications network 110, in well-known fashion.

At task 1020, telecommunications terminal 300 initializes variable S to an empty stack, and pushes on to stack S an identifier associated with the video of the outgoing media stream (e.g., a file descriptor for a document, a special identifier that indicates live-video capture, etc.). As described below, the use of a stack enables the outgoing video stream to revert to previous video content when either (i) the current video content concludes, or (ii) the current video content is stopped by the user (i.e., by drag-and-dropping the upper-left icon away from window 306, as in FIG. 7).

Task 1030 checks whether a GUI event has been generated indicating that a graphical object G (e.g., icon 310, etc.) has been drag-and-dropped onto a graphical object associated with an outgoing media-stream (e.g., icon 311, window 306, etc.). If so, execution proceeds to task 1040; otherwise, execution continues at task 1060.

At task 1040, telecommunications terminal 300 supplants the current video content of the outgoing media stream with video content V that is associated with graphical object G (e.g., the video content of a Windows Media Video file that is associated with icon G, live-capture video associated with icon G, etc.), in well-known fashion.

At task 1050, telecommunications terminal 300 pushes an identifier associated with video content V onto stack S, in well-known fashion. After task 1050 is completed, execution continues back at task 1030.

Task 1060 checks whether the depth of stack S is greater than one. If so, execution proceeds to task 1070; otherwise, execution continues back at task 1030.

Task 1070 checks whether either:
(i) a GUI event has been generated indicating that the upper-left icon in the media-stream window (e.g., videoconferencing application window 306, etc.) has been drag-and-dropped away from the window; or
(ii) the current video content of the outgoing media stream has concluded.
   If either of these two events has occurred, execution proceeds to task 1080; otherwise, execution continues back at task 1030.

At task 1080, telecommunications terminal 300:
(i) pops the top element from stack S and sets the value of variable videoID1 to this element; and
(ii) sets the value of variable videoID2 to the element that is on top of stack S after the pop operation.

At task 1090, telecommunications terminal 300 supplants the video content associated with identifier videoID1 in the outgoing media stream with the video content associated with identifier videoID2, in well-known fashion. After task 1090 is completed, execution continues back at task 1030.

As will be appreciated by those skilled in the art, although the first illustrative embodiment (as well as the second and third illustrative embodiments, described below) employs a stack to enable the outgoing video stream to revert to previous video content when the left-hand icon is drag-and-dropped away from window 306, in some embodiments it might be advantageous to always revert back to live-video capture in response to such drag-and-drop events. In such embodiments, the use of a stack would be unnecessary.

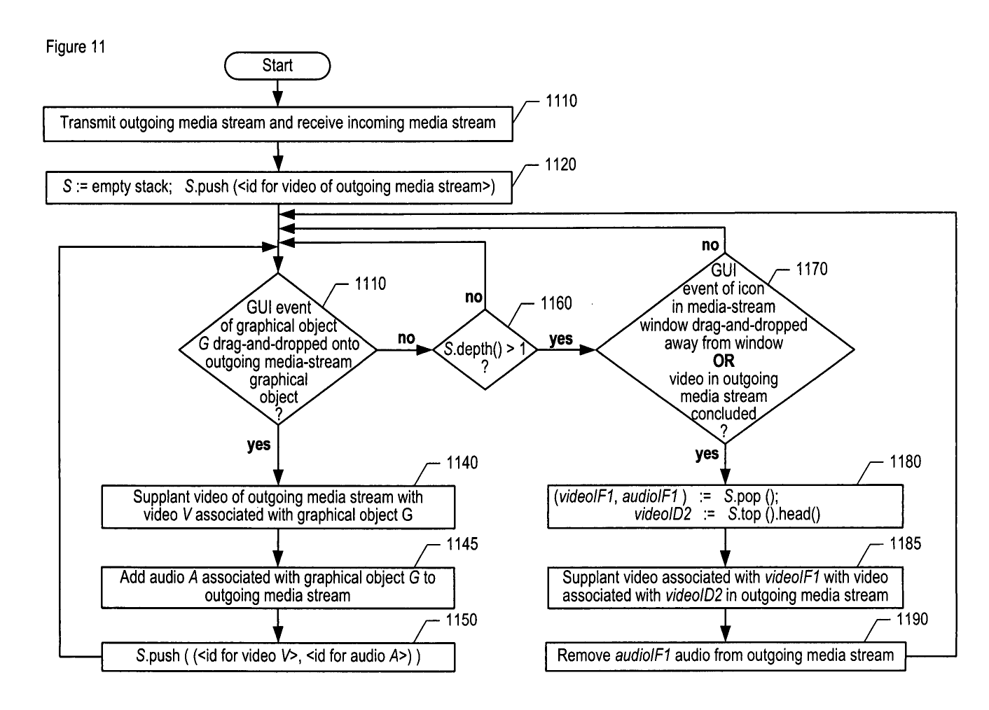

FIG. 11 depicts a flowchart of the salient tasks of telecommunications terminal 300 in response to the drag-and-drop operations of FIGS. 4 and 7, in accordance with the second illustrative embodiment of the present invention. As described above, the second illustrative embodiment of the present invention augments the first illustrative embodiment by also adding the audio content associated with the drag-and-dropped document to the audio content of the outgoing media stream. As will be appreciated by those skilled in the art, in some embodiments adding audio content might be implemented by a simple superposition of signals, while in some other embodiments, one or more adjustments (e.g., volume, etc.) might be made to audio content before it is added to the outgoing media stream in order to improve intelligibility.

Similarly, when the user of telecommunications terminal 300 drag-and-drops the upper-left icon away from videoconferencing application window 306 in the second illustrative embodiment, the audio content of the document represented by the upper-left icon is also removed from the outgoing media stream. Note that, as disclosed below in the description of the flowchart, when stack S has a depth of one, which indicates that the videoconferencing application is in its initial state or has returned to its initial state, a drag-and-drop of the upper-left icon away from window 306 is not processed because there is no other video content to “revert to.”

At task 1110, telecommunications terminal 300 transmits an outgoing media stream and receives an incoming media stream via telecommunications network 110, in well-known fashion.

At task 1120, telecommunications terminal 300 initializes variable S to an empty stack, and pushes on to stack S an identifier associated with the video of the outgoing media stream (e.g., a file descriptor for a document, a special identifier that indicates live-video capture, etc.).

Task 1130 checks whether a GUI event has been generated indicating that a graphical object G (e.g., icon 310, etc.) has been drag-and-dropped onto a graphical object associated with an outgoing media-stream (e.g., icon 311, window 306, etc.). If so, execution proceeds to task 1140; otherwise, execution continues at task 1160.

At task 1140, telecommunications terminal 300 supplants the current video content of the outgoing media stream with video content V that is associated with graphical object G (e.g., the video content of a Windows Media Video file that is associated with icon G, live-capture video associated with icon G, etc.), in well-known fashion.

At task 1145, telecommunications terminal 300 adds audio content A that is associated with graphical object G (e.g., the audio content of a Windows Media Video file represented by icon G, live-capture audio associated with icon G, etc.) to the outgoing media stream, in well-known fashion.

At task 1150, telecommunications terminal 300 pushes onto stack S a first identifier associated with video content V and a second identifier associated with audio content A, in well-known fashion. After task 1150 is completed, execution continues back at task 1130.

Task 1160 checks whether the depth of stack S is greater than one. If so, execution proceeds to task 1170; otherwise, execution continues back at task 1130.

Task 1170 checks whether either:
(i) a GUI event has been generated indicating that the upper-left icon in the media-stream window (e.g., videoconferencing application window 306, etc.) has been drag-and-dropped away from the window; or
(ii) the current video content of the outgoing media stream has concluded.
   If either of these two events has occurred, execution proceeds to task 1180; otherwise, execution continues back at task 1130.

At task 1180, telecommunications terminal 300:
(i) pops the top element, which is an ordered pair consisting of two identifiers, from stack S, and sets variables videoID1 and audioID1 to the first and second values of this ordered pair, respectively; and
(ii) sets variable videoID2 to the first value (i.e., head) of the ordered pair that is on top of stack S after the pop operation.

At task 1185, telecommunications terminal 300 supplants the video content associated with identifier videoID1 in the outgoing media stream with the video content associated with identifier videoID2, in well-known fashion.

At task 1190, telecommunications terminal 300 removes the audio content associated with identifier videoID1 from the outgoing media stream, in well-known fashion. After task 1190 is completed, execution continues back at task 1130.

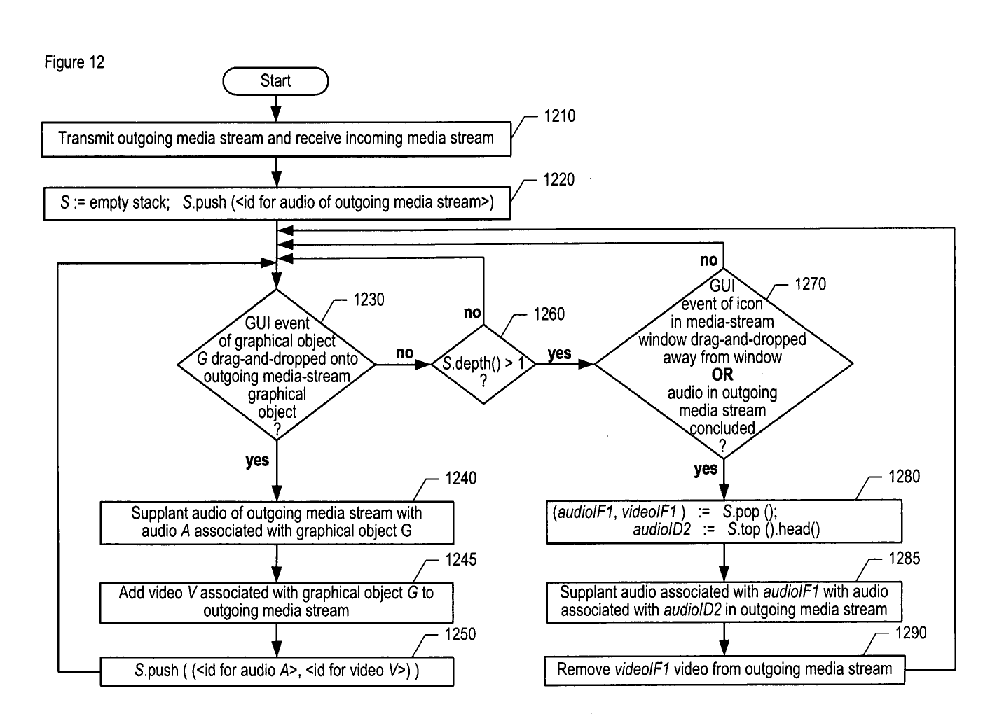

FIG. 12 depicts a flowchart of the salient tasks of telecommunications terminal 300 in response to the drag-and-drop operations of FIGS. 4 and 7, in accordance with the third illustrative embodiment of the present invention. As described above, the third illustrative embodiment is similar to the second illustrative embodiment with the roles of the audio content and video content reversed (i.e., the video content of a drag-and-dropped document is added to the current video content and the audio content is supplanted with the document's audio content.)

At task 1210, telecommunications terminal 300 transmits an outgoing media stream and receives an incoming media stream via telecommunications network 110, in well-known fashion.

At task 1220, telecommunications terminal 300 initializes variable S to an empty stack, and pushes on to stack S an identifier associated with the audio of the outgoing media stream (e.g., a file descriptor for a document, a special identifier that indicates live-audio capture, etc.).

Task 1230 checks whether a GUI event has been generated indicating that a graphical object G (e.g., icon 310, etc.) has been drag-and-dropped onto a graphical object associated with an outgoing media-stream (e.g., icon 312, window 306, etc.). If so, execution proceeds to task 1240; otherwise, execution continues at task 1260.

At task 1240, telecommunications terminal 300 supplants the current audio content of the outgoing media stream with audio content A that is associated with graphical object G (e.g., the audio content of a Windows Media Audio file that is associated with icon G, live-capture audio associated with icon G, etc.), in well-known fashion.

At task 1245, telecommunications terminal 300 adds video content V that is associated with graphical object G (e.g., the video content of a Windows Media Audio file represented by icon G, live-capture video associated with icon G, etc.) to the outgoing media stream, in well-known fashion.

At task 1250, telecommunications terminal 300 pushes onto stack S a first identifier associated with audio content A and a second identifier associated with video content V, in well-known fashion. After task 1250 is completed, execution continues back at task 1230.

Task 1260 checks whether the depth of stack S is greater than one. If so, execution proceeds to task 1270; otherwise, execution continues back at task 1230.

Task 1270 checks whether either:
(i) a GUI event has been generated indicating that the upper-left icon in the media-stream window (e.g., audioconferencing application window 306, etc.) has been drag-and-dropped away from the window; or
(ii) the current audio content of the outgoing media stream has concluded.
   If either of these two events has occurred, execution proceeds to task 1280; otherwise, execution continues back at task 1230.

At task 1280, telecommunications terminal 300:
(i) pops the top element, which is an ordered pair consisting of two identifiers, from stack S, and sets variables audioID1 and videoID1 to the first and second values of this ordered pair, respectively; and
(ii) sets variable audioID2 to the first value (i.e., head) of the ordered pair that is on top of stack S after the pop operation.

At task 1285, telecommunications terminal 300 supplants the audio content associated with identifier audioID1 in the outgoing media stream with the audio content associated with identifier audioID2, in well-known fashion.

At task 1290, telecommunications terminal 300 removes the video content associated with identifier videoID1 from the outgoing media stream, in well-known fashion. After task 1290 is completed, execution continues back at task 1230.

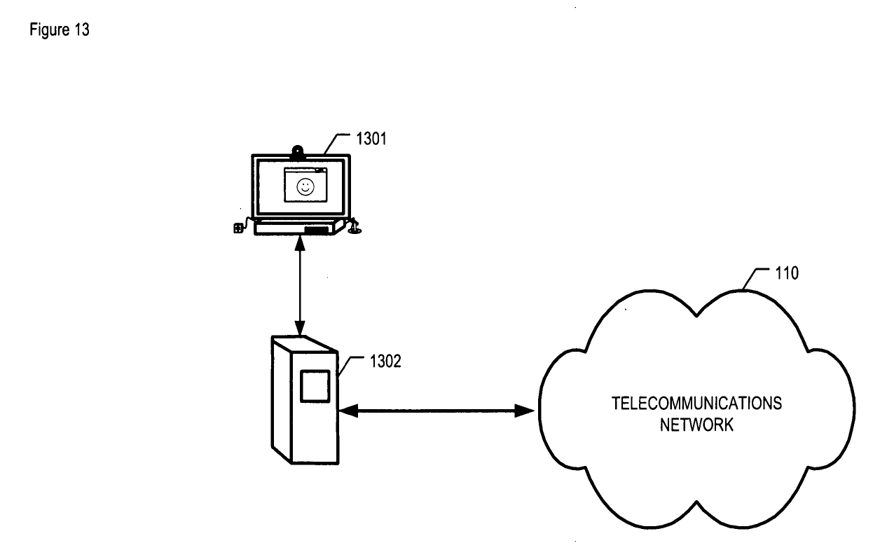

As will be appreciated by those skilled in the art, although in the illustrative embodiments above telecommunications terminal 300 does the supplanting, adding, and removing of audio and video content, some other embodiments of the present invention might employ a client/server architecture in which a server performs these tasks. For example, FIG. 13 depicts an illustrative client/server architecture comprising telecommunications terminal 1301 and server 1302, interconnected as shown. In the illustrative architecture of FIG. 13, telecommunications terminal 1301 provides its user with the same graphical user interface (GUI) as telecommunications terminal 300, but, upon receiving pertinent events generated by the GUI, sends an appropriate message to server 1302 to supplant, add, or remove content accordingly with respect to the outgoing media stream. It will be clear to those skilled in the art, after reading this specification, how to make and use embodiments of the present invention that employ a client/server architecture such as the illustrative architecture of FIG. 13.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising:
(a) transmitting to a remote telecommunications terminal a first media stream that comprises a first video signal and an audio signal;
(b) receiving from said remote telecommunications terminal a second media stream; and
(c) when a first graphical object that is associated with a document is drag-and-dropped in a graphical user interface onto a second graphical object that is associated with said first media stream, supplanting said first video signal in said first media stream with a second video signal that is based on said document.

2. The method of claim 1, further comprising:
(d) supplanting said second video signal with said first video signal in said first media stream when said first graphical object is drag-and-dropped away from said second graphical object.

3. The method of claim 1, further comprising:
(d) supplanting said second video signal with said first video signal in said first media stream when a third graphical object that is associated with said first video signal is drag-and-dropped onto said second graphical object.

4. The method of claim 1, further comprising:
(d) supplanting said second video signal with said first video signal in said first media stream when said second video signal has concluded.

5. The method of claim 1 wherein said first graphical object and said second graphical object are icons.

6. The method of claim 1 wherein said second graphical object is a window.

7. A method comprising:
(a) displaying in a graphical user interface a first graphical object that is associated with a document and a second graphical object that is associated with a media stream; and
(b) generating a first event when said first graphical object is drag-and-dropped onto said second graphical object;
wherein said first event causes a first video signal in said media stream to be supplanted with a second video signal that is based on said document.

8. The method of claim 7, further comprising:
(c) generating a second event when, after said first event, said first graphical object is drag-and-dropped away from said second graphical object;
wherein said second event causes said second video signal in said first media stream to be supplanted with said first video signal.

9. The method of claim 7, further comprising:
(c) generating a second event when, after said first event, a third graphical object that is associated with said first video signal is drag-and-dropped onto said second graphical object;
wherein said second event causes said second video signal in said first media stream to be supplanted with said first video signal.

10. The method of claim 7, further comprising:
(c) erasing said first graphical object at said second graphical object when said second video signal has concluded.

11. The method of claim 7, further comprising:
(c) displaying a third graphical object that is associated with said first video signal in lieu of said first graphical object when said second video signal has concluded.

12. The method of claim 7 wherein said first graphical object and said second graphical object are icons.

13. The method of claim 7 wherein said second graphical object is a window.

14. A method comprising:
(a) transmitting to a remote telecommunications terminal a first media stream that comprises a first video signal and a first audio signal; and
(b) when a first graphical object that is associated with a document is drag-and-dropped in a graphical user interface onto a second graphical object that is associated with said first media stream,
(i) adding a second audio signal that is based on said document to said first media stream, and
(ii) supplanting said first video signal in said first media stream with a second video signal that is based on said document.

15. The method of claim 14, further comprising:
(c) receiving from said remote telecommunications terminal a second media stream.

16. The method of claim 14, further comprising:
(d) when said first graphical object is drag-and-dropped away from said second graphical object,
(i) removing said second audio signal from said first media stream, and
(ii) supplanting said second video signal in said first media stream with said first video signal.

17. A method comprising:
(a) transmitting to a remote telecommunications terminal a first media stream that comprises a first video signal and a first audio signal; and
(b) when a first graphical object that is associated with a document is drag-and-dropped in a graphical user interface onto a second graphical object that is associated with said first media stream,
(i) adding a second video signal that is based on said document to said first media stream, and
(ii) supplanting said first audio signal in said first media stream with a second audio signal that is based on said document.

18. The method of claim 17, further comprising:
(c) receiving from said remote telecommunications terminal a second media stream.

19. The method of claim 17, further comprising:
(d) when said first graphical object is drag-and-dropped away from said second graphical object,
(i) removing said second video signal from said first media stream, and
(ii) supplanting said second audio signal in said first media stream with said first audio signal.

20. A method comprising:
(a) displaying in a graphical user interface a first graphical object that represents a document and a second graphical object that represents a media stream; and
(b) generating a first event when said first graphical object is drag-and-dropped onto said second graphical object;
wherein said first event causes:
(i) an audio signal that is based on said document to be added to said media stream, and
(ii) a first video signal in said media stream to be supplanted with a second video signal that is based on said document.

21. The method of claim 20, further comprising:
(c) generating a second event when, after said first event, said first graphical object is drag-and-dropped away from said second graphical object;
wherein said second event causes:
(i) said audio signal that is based on said document to be removed from said media stream, and
(ii) said second video signal in said media stream to be supplanted with said first video signal.

22. A method comprising:
(a) displaying in a graphical user interface a first graphical object that represents a document and a second graphical object that represents a media stream; and
(b) generating a first event when said first graphical object is drag-and-dropped onto said second graphical object;
wherein said first event causes:
(i) a video signal that is based on said document to be added to said media stream, and
(ii) a first audio signal in said media stream to be supplanted with a second audio signal that is based on said document.

23. The method of claim 22, further comprising:
(c) generating a second event when, after said first event, said first graphical object is drag-and-dropped away from said second graphical object;
wherein said second event causes:
(i) said video signal that is based on said document to be removed from said media stream, and
(ii) said second audio signal in said media stream to be supplanted with said first audio signal.
